(19) United States
(12) Patent Application Publication
(10) Pub. No.: US 2021/0217112 A1
(43) Pub. Date: Jul. 15, 2021

(54) OBTAINING WEATHER INFORMATION PRIOR TO SCHEDULING REAL ESTATE SHOWING

(71) Applicant: CARRIER CORPORATION, Palm Beach Gardens, FL (US)

(72) Inventor: Sandeep Reddy TUDI, Hyderabad, Telangana (IN)

(21) Appl. No.: 17/059,941

(22) PCT Filed: Aug. 29, 2019
(86) PCT No.: PCT/US2019/048863

§ 371 Date: Nov. 30, 2020

(30) Foreign Application Priority Data
Sep. 14, 2018 (IN) 201811034755

(51) Int. Cl. G06Q 50/16; G06Q 10/10; H04W 4/90

(52) U.S. Cl. CPC G06Q 50/16; H04W 4/90; G06Q 10/1095

(57) ABSTRACT

A method of scheduling a showing of a premises includes sending, from a mobile device, a request for the showing of the premises, the request including a location and a time of the showing; obtaining a weather forecast for the showing in response to the location and the time of the showing; and generating a warning message, at the mobile device, in response to the weather forecast.

### BACKGROUND

The subject matter disclosed herein generally relates to real estate showing systems, more particularly, to a real estate showing system that obtains weather information prior to scheduling a showing.

In existing real estate showing systems, the agent schedules an appointment with a buyer to perform a showing on a listing. This appointment may be one or more days later than the current date. In some cases, inclement weather occurs at the day and time of the showing, due to which the showing will get canceled at the last minute. This is time consuming and frustrating, as the agent has to again schedule another showing appointment on another day.

### SUMMARY

According to an embodiment, a method of scheduling a showing of a premises includes sending, from a mobile device, a request for the showing of the premises, the request including a location and a time of the showing; obtaining a weather forecast for the showing in response to the location and the time of the showing; and generating a warning message, at the mobile device, in response to the weather forecast.

In addition to one or more of the features described herein, or as an alternative, further embodiments may include wherein generating the warning message comprises generating the warning message when the weather forecast for the showing corresponds to a predetermined warning category.

In addition to one or more of the features described herein, or as an alternative, further embodiments may include wherein upon generating the warning message, prompting to reschedule the showing.

In addition to one or more of the features described herein, or as an alternative, further embodiments may include transmitting a notification of the showing to a buyer device.

In addition to one or more of the features described herein, or as an alternative, further embodiments may include receiving the notification of the showing at the buyer device; and obtaining, at the buyer device, the weather forecast for the showing in response to the location and the time of the showing.

In addition to one or more of the features described herein, or as an alternative, further embodiments may include generating a warning message, at the buyer device, in response to the weather forecast.

In addition to one or more of the features described herein, or as an alternative, further embodiments may include wherein generating the warning message at the buyer device comprises generating the warning message when the weather forecast for the showing corresponds to a predetermined warning category.

In addition to one or more of the features described herein, or as an alternative, further embodiments may include wherein upon generating the warning message at the buyer device, prompting, at the buyer device, to reschedule the showing.

According to an embodiment a real estate system configured to schedule a showing of a premises includes: a central authority configured to receive, from a mobile device, a request for the showing of the premises, the request including a location and a time of the showing; the central authority configured to obtain a weather forecast for the showing in response to the location and the time of the showing; and the central authority configured to generate a warning message, for the mobile device, in response to the weather forecast.

In addition to one or more of the features described herein, or as an alternative, further embodiments may include wherein generating the warning message comprises generating the warning message when the weather forecast for the showing corresponds to a predetermined warning category.

In addition to one or more of the features described herein, or as an alternative, further embodiments may include wherein upon generating the warning message, prompting to the mobile device to reschedule the showing.

In addition to one or more of the features described herein, or as an alternative, further embodiments may include the central authority transmitting a notification of the showing to a buyer device.

In addition to one or more of the features described herein, or as an alternative, further embodiments may include the central authority sending the weather forecast for the showing to the buyer device in response to the location and the time of the showing.

In addition to one or more of the features described herein, or as an alternative, further embodiments may include generating a warning message, at the buyer device, in response to the weather forecast.

In addition to one or more of the features described herein, or as an alternative, further embodiments may include wherein generating the warning message at the buyer device comprises generating the warning message when the weather forecast for the showing corresponds to a predetermined warning category.

In addition to one or more of the features described herein, or as an alternative, further embodiments may include wherein upon generating the warning message at the buyer device, prompting, at the buyer device, to reschedule the showing.

Technical effects of embodiments of the present disclosure include the provision of a real estate showing system that retrieves weather information for a proposed showing and notifies the parties of the weather prior to confirming to the proposed showing.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts a real estate control system with real-time communications features in an example embodiment;

FIG. 2 depicts a mobile device interfacing with a weather information system in an example embodiment;

FIG. 3 depicts a flow chart of a process of scheduling a showing of a premises in an example embodiment;

FIG. 4 depicts a flow chart of a process of scheduling a showing of a premises in an example embodiment.

### DETAILED DESCRIPTION

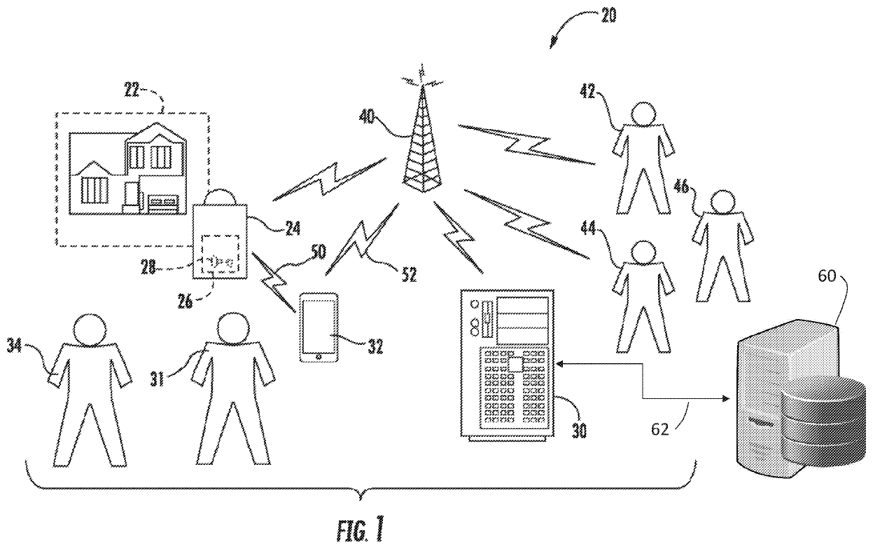

FIG. 1 depicts a real estate system with real-time communications features in an example embodiment. Described below are implementations of a real estate system in which at least one premises is secured by a lockbox securing the key to the premises. There is at least one mobile device associated with a user seeking to access the lockbox and programmed with the capability to make an access request to the lockbox. The real estate system also provides for enhanced scheduling of showings by retrieving a weather forecast prior to confirming a showing.

In the real estate context, some lockboxes may be open to all authorized accesses without constraints, such as, e.g., the time of day for the requested access or who is present to accompany the user during the visit to the premises. For such a lockbox subject to open access, the only requirement is that the user be authorized, e.g., being recognized as user within the real estate control system and/or having up-to-date credentials for the type of access being requested. Assuming the user is authorized, the user simply makes the access request with his mobile device, which typically requires entry of a PIN or other similar code, and the lockbox is unlocked to allow the user to access the key to the premises.

FIG. 1 illustrates an embodiment of a real estate system 20. At least one premises 22 is secured with a lockbox 24 having a locked compartment 26 in which a key 28 to the premises 22 is stored. The system 20 also includes a central authority 30. At least one user 31 has a mobile device 32. As is discussed below, the mobile device 32 runs software in the form of an access application loaded onto the mobile device 32 and assigned to the user 31. FIG. 1 also shows a prospective visitor 34. As is discussed further below, the exemplary user 31 is a real estate agent (showing agent) and the prospective visitor 34 is a prospective buyer to whom the user 31 intends to show the premises.

The central authority 30 and the mobile device 32 can communicate with each other over a wireless network 40 (optionally including hard links such as wired or fiber optic Internet links). More particularly, the access application using the operating system and hardware of the mobile device 32 may communicate with the central authority 30. Other parties may also communicate with the central authority 30 and/or the mobile device 32 via the network 40 or otherwise. Among examples are the listing agent (or agency) 42, the user's agency 44, and a board or association 46 (e.g., a regional real estate board that manages credentials within a geographic region). Access of these parties may be via the internet or successor network using hardware (servers, computers, or even mobile phones, of those respective users). Exemplary such user access is web-based html via a browser or via mobile phone application (which might be the same access application escribed herein). Typically, but not necessarily, the premises, the central authority 30 and the other parties are remotely located from each other (often, however, the listing agency may be the user's agency; in some implementations, the regional board or the like might also serve as the central authority).

The central authority 30 administers the access privileges of users and the access preferences of approval parties for premises and lockboxes 24 within the system. The central authority 30 includes one or more computers or servers with appropriate communications equipment for communications over at least the wireless service network, and possibly other public and/or private networks. These computers or servers individually and/or collectively may include appropriate processors, memory, storage, communications interfaces, and the like. The processor and memory execute programs held in the storage to perform basic computer functions and the specific functions associated with acting as a central authority. The central authority 30 typically includes a database in said storage, which typically includes an identification of each user, user status, the access application on the mobile device assigned to the user, each premises within the system and its status, and each lockbox within the system and its status, etc. Through communication links, the central authority 30 may optionally provide other services, including informational updates, programming updates, and references.

The mobile device 32 is typically a cellular device, a satellite device or similar portable wireless communications device with at least a voice channel for communicating within or among wireless networks, such as the wireless network 40. Advantageously, networks that support at least one data channel in addition to the voice channel provide enhanced capabilities. Several such cellular networks, as well as their associated cellular handsets and communications protocols, are referred to as GPRS over GSM, 1×RTT over CDMA, and LTE. Of course, other similar networks, whether they exist currently or will be developed in the future, can also be used.

The mobile device 32 is programmed to function as an access device. In exemplary implementations, the mobile device 32 is a smartphone, having one or more processors, memory, and storage. The mobile device 32 is programmed with the access application that allows it to communicate wirelessly with the lockbox 24. For example, the mobile device 32 and the lockbox 24 can have transceivers and associated circuitry to enable infrared (IR) or other form of optical or radiofrequency (RF) (e.g., Bluetooth or near field communication (NFC)) communication when within proximity of each other. The central authority 30 can unlock the lockbox 24 upon verifying that identify of the agent 31 and authorization to access the premises 22. Further details of the real estate system 20 may be found in U.S. Patent Application Publication No. 20160321847, the entire contents of which are incorporated herein by reference.

The central authority 30 may be used to coordinate showings of the premises 22, by serving as a central calendaring system, so that multiple users can schedule showings of premises(s) without overlapping. The central authority 30 is in communication with a weather information system 60. The weather information system 60 includes one or more computers or servers with appropriate communications equipment for communications with the central authority 30 or directly to mobile devices 32. The weather information system 60 may communicate with the central authority 30 over at least the network 40, and/or other public and/or private networks 62. The weather information system 60 contains weather predictions for a wide range of locations (e.g., from local to regional) and times (e.g., hourly, daily, weekly, etc.).

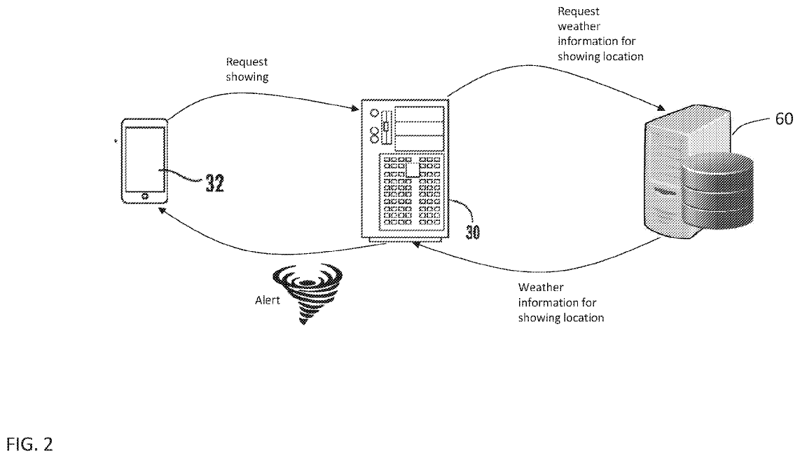

FIG. 2 depicts a mobile device 32 interacting with the central authority 30 and weather information system 60 in an example embodiment. If an agent wishes to schedule a showing of a premises 22, a request for a showing is sent to the central authority 30. Assuming the time for the showing is available, the central authority 30 communicates with the weather information system 60 and requests the weather forecast for the requested premises 22 at the requested day and time. The weather information system 60 replies back to the central authority 30 with the weather forecast for the requested premises at the requested day and time. The weather information system 60 may send the weather forecast with one or more fields that may be interpreted by the central authority 30. The weather forecast may identify common weather conditions (e.g., sunny, rainy, cloudy, snow, etc.) and also include weather alerts (e.g., flash flood warning, heavy rain, high wind advisory, frost warning, etc.). The central authority 30 then forwards the weather forecast to the mobile device 32. The central authority 30 may also generate a warning message if the weather forecast corresponds to one or more predefined warning categories. The predefined warning categories may be programmed in the central authority 30 by an administrator of the real estate system 20.

FIG. 2 depicts the mobile device 32 communicating with the central authority 30 to retrieve a weather forecast from the weather information system 60. In other embodiments, the mobile device 32 can retrieve the weather forecast directly from the weather information system 60 over network 40. As noted above, the mobile device 32 may generate a warning message if the weather forecast matches a predefined warning category, which may be selected on the mobile device 32.

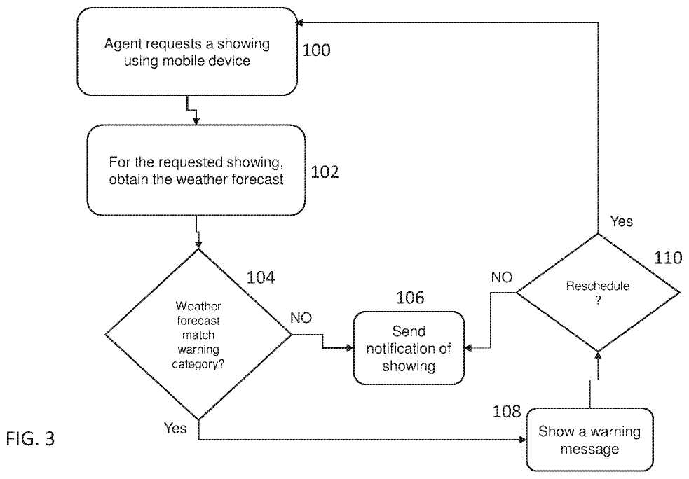

FIG. 3 depicts a flow chart of a process of scheduling a showing of a premises 22 by a first user, such as a real estate agent 31, in an example embodiment. The process begins at 100 where the agent uses the mobile device 32 to submit a request for a showing of a premises 22 including the premises location and day and time of the showing. At 102, the weather forecast for the requested showing is obtained from the weather information system 60. At 104, the weather forecast for the requested showing is compared to the predefined warning categories. If the weather forecast for the requested showing does not match a predefined warning category, flow proceeds to 106 where a notification of the showing may be sent to another user, such as a potential buyer of the premises.

If the weather forecast for the requested showing matches a predefined warning category at 104, then flow proceeds to 108 where a warning message is generated on the mobile device 32. The warning message may include the weather forecast for the requested showing. At 110, the user may reschedule the requested showing, and the process flow to 100. If the showing is not rescheduled at 110, flow proceeds to 106 where a notification of the showing may be sent to another user, such as a potential buyer of the premises.

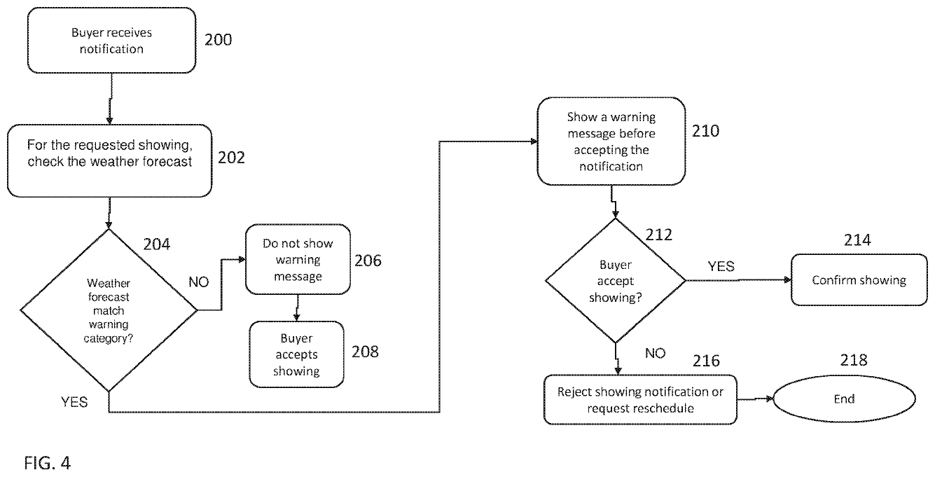

FIG. 4 depicts a flow chart of a process of confirming a showing of the premises 22, by a second user, such as a buyer 34, in an example embodiment. Once the agent sends the notification of a showing at 106 in FIG. 3, the buyer will received the notification of the showing at 200 in FIG. 4. The buyer may receive the notification on a mobile device similar to mobile device 32. At 202, the weather forecast for the showing is obtained. The weather forecast for the showing may be the original weather forecast obtained at 102 of FIG. 3, or the mobile device of the buyer may be used to obtain the most recent weather forecast for the showing from the weather information system 60, either directly or through the central authority 30.

At 204, the weather forecast for the showing is compared to predefined warning categories. The buyer mobile device may include predefined warning categories different from those used by the agent or the central authority 30. If the weather forecast for the showing does not match a predefined warning category, flow proceeds to 206 where no weather warning is produced, and the buyer can accept the showing at 208. At 208, the buyer can request to reschedule if the day/time is not convenient.

If the weather forecast for the showing matches a predefined warning category at 204, then flow proceeds to 210 where a warning message is generated on the buyer mobile device. The warning message may include the weather forecast for the showing. At 212, if the buyer accepts and confirms the showing, flow proceeds to 214 where the showing date and time is confirmed to the agent mobile device. At 212, if the buyer does not accept the showing, flow proceeds to 216 where the buyer can reject the showing or request a reschedule of the showing. The process then ends at 218.

Embodiments described herein provide a warning message is weather associated with a showing is abnormal, which corresponds to matching one or more predefined warning categories. This allows the agent or the buyer to reschedule the showing in a timely manner. This avoids last minute cancellations of scheduled showings, which saves time for both the agent and the buyer.

As described above, embodiments can be in the form of processor-implemented processes and devices for practicing those processes, such as a processor in mobile device 32 or central authority 30. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations. Further, one of ordinary skill in the art will appreciate that the steps described in conjunction with the illustrative figures may be performed in other than the recited order, and that one or more steps illustrated may be optional.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method of scheduling a showing of a premises, the method comprising:
sending, from a mobile device, a request for the showing of the premises, the request including a location and a time of the showing;
obtaining a weather forecast for the showing in response to the location and the time of the showing; and
generating a warning message, at the mobile device, in response to the weather forecast.

2. The method of claim 1 wherein generating the warning message comprises generating the warning message when the weather forecast for the showing corresponds to a predetermined warning category.

3. The method of claim 1 wherein upon generating the warning message, prompting to reschedule the showing.

4. The method of claim 1 further comprising transmitting a notification of the showing to a buyer device.

5. The method of claim 4 further comprising receiving the notification of the showing at the buyer device;
and obtaining, at the buyer device, the weather forecast for the showing in response to the location and the time of the showing.

6. The method of claim 5 further comprising generating a warning message, at the buyer device, in response to the weather forecast.

7. The method of claim 6 wherein generating the warning message at the buyer device comprises generating the warning message when the weather forecast for the showing corresponds to a predetermined warning category.

8. The method of claim 7 wherein upon generating the warning message at the buyer device, prompting, at the buyer device, to reschedule the showing.

9. A real estate system configured to schedule a showing of a premises, the system comprising:
a central authority configured to receive, from a mobile device, a request for the showing of the premises, the request including a location and a time of the showing;
the central authority configured to obtain a weather forecast for the showing in response to the location and the time of the showing; and
the central authority configured to generate a warning message, for the mobile device, in response to the weather forecast.

10. The system of claim 9 wherein generating the warning message comprises generating the warning message when the weather forecast for the showing corresponds to a predetermined warning category.

11. The system of claim 9 wherein upon generating the warning message, prompting to the mobile device to reschedule the showing.

12. The system of claim 9 further comprising the central authority transmitting a notification of the showing to a buyer device.

13. The system of claim 12 further comprising the central authority sending the weather forecast for the showing to the buyer device in response to the location and the time of the showing.

14. The system of claim 13 further comprising generating a warning message, at the buyer device, in response to the weather forecast.

15. The system of claim 14 wherein generating the warning message at the buyer device comprises generating the warning message when the weather forecast for the showing corresponds to a predetermined warning category.

16. The system of claim 15 wherein upon generating the warning message at the buyer device, prompting, at the buyer device, to reschedule the showing.
